(19) United States
(12) Patent Application Publication
(10) Pub. No.: US 2018/0336532 A1
(43) Pub. Date: Nov. 22, 2018

(54) CALENDAR RANGE SEARCHING

(71) Applicant: Microsoft Technology Licensing, LLC, Redmond, WA (US)

(72) Inventor: Benjamin Alan HILLERY, Snohomish, WA (US)

(21) Appl. No.: 15/596,616

(22) Filed: May 16, 2017

(51) Int. Cl. G06Q 10/10; G06F 17/30

(52) U.S. Cl. CPC G06Q 10/1095; G06F 17/30483; G06F 17/30327

(57) ABSTRACT

Calendar appointments are indexed using a modified relational interval tree which identifies a fork node for each appointment, and indexes the appointment based on the identified fork node. When a query interval is received, a fork node is identified for the query interval and the index is searched using the fork node identified for the query interval. Intersecting appointments are identified as those appointments that an interval that includes the fork node for the query interval, and those appointments that have a fork node on a path traced through the modified RI tree to obtain the fork node for the query interval, and that overlap with the query interval.

### BACKGROUND

Computing systems are currently in wide use. Some computing systems include calendar systems that allow users to perform calendar operations. For instance, calendar operations can include scheduling appointments and tasks, sending and responding to meeting requests, among a wide variety of other things.

Such calendar systems often identify appointments that happen within a given date range. For instance, when a calendar computing system is displaying a user's calendar (such as using a month view), the calendar computing system first identifies the various appointments (such as meetings, tasks, etc.) that occur during the displayed date range (e.g., during the month being displayed).

It can be relatively straight forward to identify some appointments that occur within the date range. This can be the case, for instance, where the appointment has a start time and/or an end time within the date range. However, it is not always straight forward. For instance, assume that the duration to be displayed is a single day (such as Tuesday). In order for the calendar computing system to identify the appointments that occur within that date range, the calendar computing system needs to find all appointments that have either a start time or an end time, or both, on Tuesday. However, it also needs to find any appointments that start before that time range and end after that time range. For instance, assume that an appointment starts Monday and ends Friday. That calendar appointment often does not refer to “Tuesday” at all. It simply has a start time on Monday and an end time on Friday. Thus, it can be difficult to identify such an appointment when attempting to identify all appointments that occur on Tuesday.

The discussion above is merely provided for general background information and is not intended to be used as an aid in determining the scope of the claimed subject matter.

### SUMMARY

Calendar appointments are indexed using a modified relational interval (RI) tree which identifies a fork node for each appointment, and indexes the appointment based on the identified fork node. When a query interval is received, the index is searched using the start and end times of the query interval, to identify intersecting appointments. Intersecting appointments are those appointments that have fork nodes encompassed by the start and end times of the query interval. Potentially intersecting appointments are those appointments that have a fork node that lies upon a path, traced through the modified RI tree, to arrive at either the start or end time of the query interval. The potentially intersecting appointments are linearly processed to determine whether they overlap with the query interval and are, thus, intersecting appointments.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2A shows one example of a binary tree that illustrates fork nodes for intervals.

FIG. 2B graphically illustrates how fork nodes are determined for intervals using a binary tree.

FIG. 3 shows one example of a calendar range query index that indexes appointments by fork node.

FIG. 4 is a flow diagram illustrating one example of the operation of the architecture shown in FIG. 1 in indexing appointments by fork node.

FIGS. 5A and 5B (collectively referred to herein as FIG. 5) show a flow diagram illustrating one example of the operation of the architecture shown in FIG. 1 in receiving a query interval and identifying appointments that intersect with the query interval.

FIG. 6 is a block diagram showing one example of the architecture illustrated in FIG. 1, deployed in a cloud computing architecture.

FIGS. 7-9 show examples of mobile devices that can be used in the architectures shown in the previous figures.

FIG. 10 is a block diagram of one example of a computing environment that can be used in the architectures shown in the previous figures.

### DETAILED DESCRIPTION

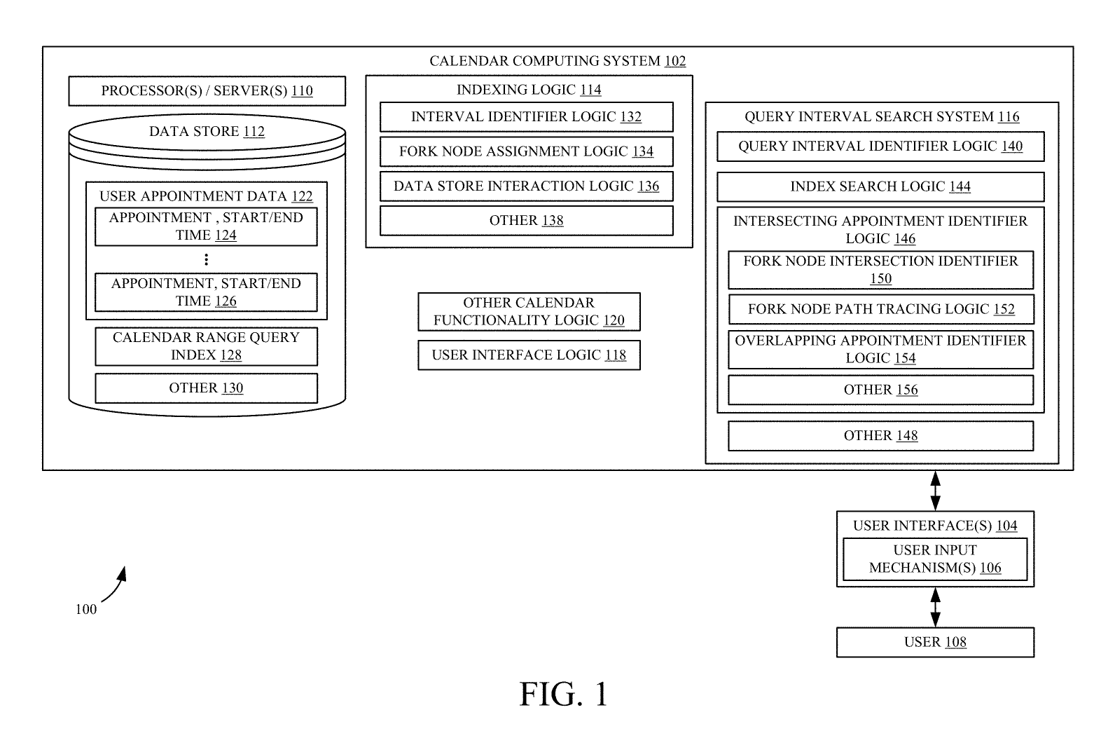

FIG. 1 is a block diagram of one example of a computing system architecture 100. Architecture 100 shows calendar computing system 102 generating user interfaces 104 with user input mechanisms 106, for interaction by user 108. User 108 illustratively interacts with user input mechanisms 106 in order to control and manipulate calendar computing system 102.

Calendar computing system 102, itself, illustratively includes one or more processors or servers 110, data store 112, indexing logic 114, query interval search system 116, user interface logic 118, and it can include a wide variety of other calendar functionality logic 120. Data store 112 illustratively stores calendar data for user 108 (and it can store calendar data for other users as well). The calendar data can include user appointment data 122 which stores scheduled appointments 124-126. Each scheduled appointment may include start time and end time indicators that indicate the start and end time of the corresponding appointment. Each appointment can also include an appointment identifier, a textual description of the appointment, a list of other people who are attending the appointment, etc.

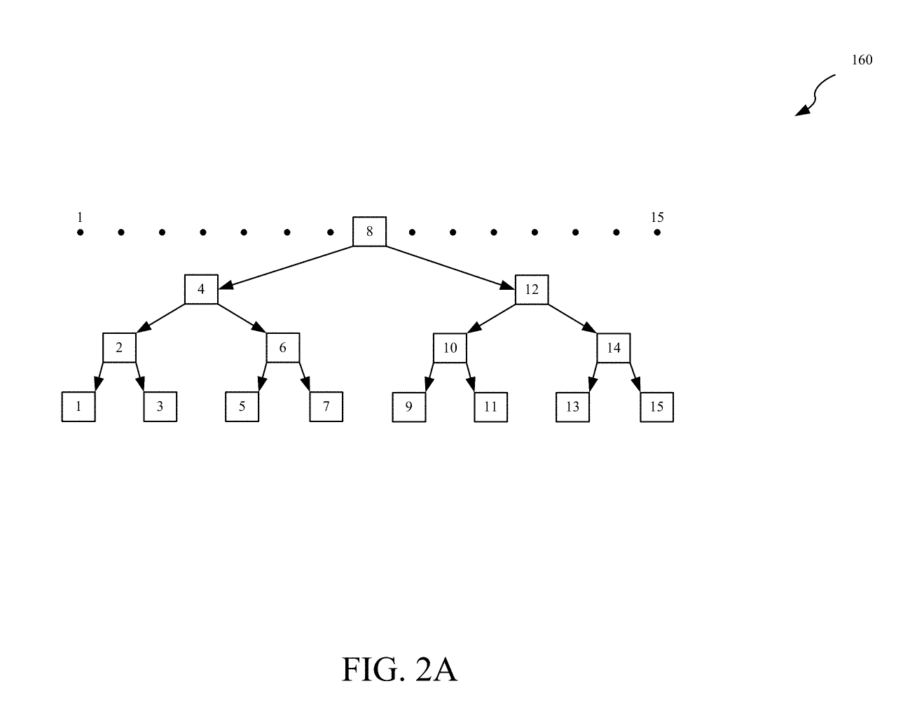

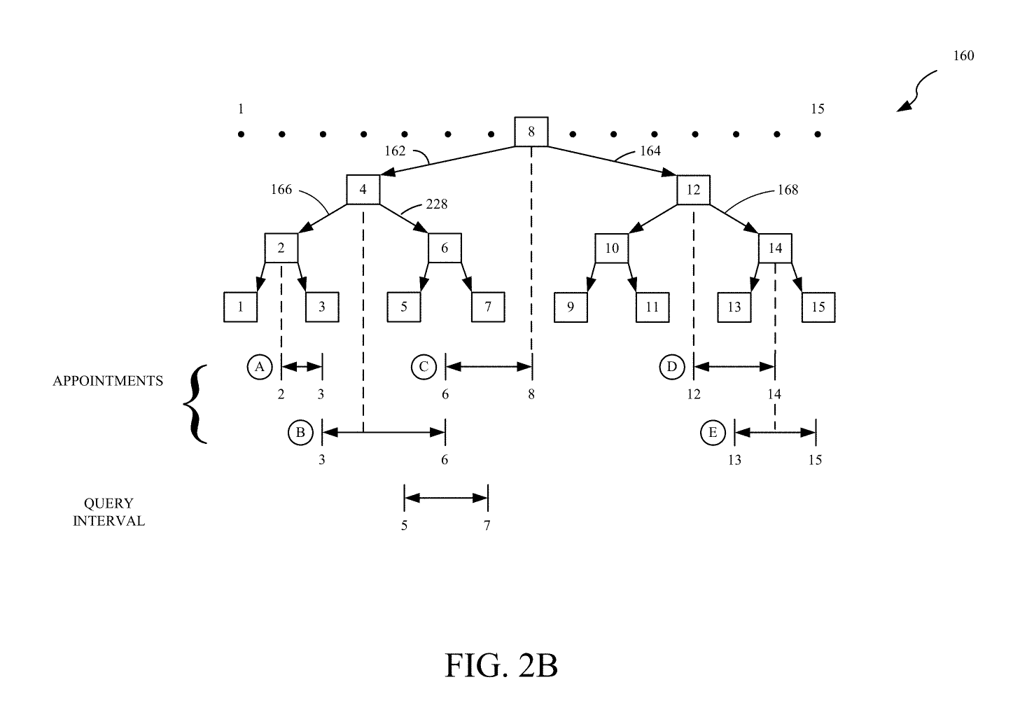

Data store 112 also illustratively includes calendar range query index 128 (which can be stored elsewhere). Index 128 illustratively indexes each of the appointments 124-126, based on a fork node that is identified using the concept of a binary tree. The fork node can be identified using a binary tree structure or it can be calculated directly without using a binary tree (or other equivalent means), which may be referred to as a modified relational interval (RI) tree. This is described in greater detail below with respect to FIGS. 2A-4. Data store 112 can include a wide variety of other things as well. This is indicated by block 130.

Indexing logic 114 illustratively receives appointments 124-126 and generates index entries for them in calendar range query index 128. Logic 114 illustratively includes interval identifier logic 132, fork node assignment logic 134, data store interaction logic 136, and it can include a wide variety of other items 138. Interval identifier logic 132 illustratively identifies the start and end times for the appointment being indexed. Fork node assignment logic 134 illustratively uses a binary tree to identify a fork node corresponding to the appointment being indexed. Data store interaction logic 136 illustratively interacts with data store 112 in order to store an index entry, for the appointment being indexed, in calendar range query index 128.

Query interval search system 116 can illustratively be used to provide a query interval, and to search for various appointments 124-126 that intersect with the query interval. In one example, the query interval may include a start and end time and appointments that intersect with the query interval are those that at least partially overlap with the query interval, as defined by its start and end time. Query interval search system 116 includes query interval identifier logic 140, index search logic 144, and intersecting appointment identifier logic 146, and it can include a wide variety of other items 148. Intersecting appointment identifier logic 146 illustratively includes fork node identifier 150, fork node path tracing logic 152, overlapping appointment identifier logic 154, and it can include a wide variety of other items 156.

Query interval identifier logic 140 illustratively identifies the start and end times of the query interval, and index search logic 144 searches calendar range query index 128, based upon the start and end times identified by logic 140 for the query interval. Intersecting appointment identifier logic 146 identifies all appointments 124-126 which intersect with the query interval. In doing so, fork node intersection identifier 150 identifies appointments 124-126 that have fork nodes contained by the start and end times identified for the query interval. Fork node path tracing logic 152 illustratively identifies appointments of interest (or potentially interesting appointments) that have their own fork nodes that are on paths through the binary tree that were used to arrive at the start and end times for the query interval. The appointments of interest (or potentially intersecting appointments) are then analyzed by overlapping appointment identifier logic 154, which processes the appointments of interest linearly. It illustratively selects an appointment of interest and determines whether it overlaps with the query interval based on the start and/or end time of the appointment of interest. Intersecting appointment identifier logic 146 then outputs, as intersecting appointments, those appointments identified as intersecting appointments by fork node intersection identifier 150 and by overlapping appointment identifier logic 154.

A static relational interval (RI) tree will now be discussed, prior to discussing how appointments are indexed and searched (given a query interval) in more detail. FIG. 2A is a diagram showing a simple binary tree 160 that has nodes labeled as integer numbers (in this case, numbers 1-15). The backbone of a static RI-Tree is implemented the same as binary tree 160, with its nodes labeled as integer numbers. The value of the trunk of the tree is set to an integer number that bisects the numbers in the tree (in this case, the trunk is 8). For purposes of the present discussion, dates (or specific times) can be assigned to each integer (or node) in the tree 160. This can be done directly, or by using a mapping.

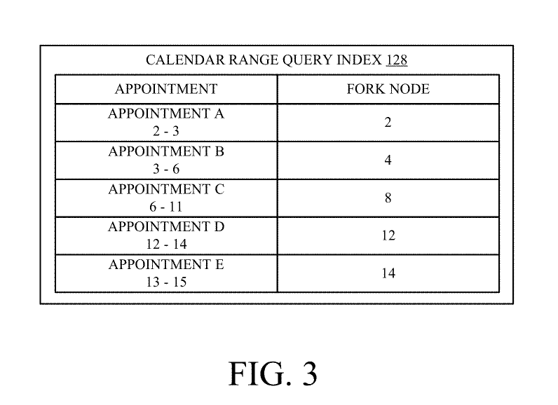

Each node on tree 160 can be referred to as a fork node. The lowest level of fork nodes may also be referred to as leaf nodes. When placing an interval on tree 160, the fork nodes determine where the interval is inserted into the tree 160. Its value is used in the node column of the calendar range query index 128, that indexes each interval by its corresponding fork node, and that is discussed in greater detail below with respect to FIG. 3.

For example, assuming an interval (such as an appointment 124) has a lower bound and an upper bound that correspond to its start and end times, respectively. Assume also that the lower bound [lower] and the upper bound [upper] are integers. Then, the fork node corresponding to the interval (or appointment) is defined as the topmost node w in the following relation: lower⇐w⇐upper. As described below, fork node assignment logic 134 and fork node path tracing logic 152 can iterate through tree 160 from the trunk down to the fork node satisfying the above relation. That will be the fork node corresponding to the interval (or appointment).

An example may be helpful.

FIG. 2B is a graphical illustration of how intervals are placed in tree 160 so that fork nodes are identified using tree 160. In one example, tree 160 works by taking a relatively large time period and dividing that time period into individual instants or moments that correspond to the integers or nodes in the tree. For instance, the relatively large period maybe a year, and the individual instants or moments may be individual minutes within that year. Tree 160 thus descends from its trunk to the leaves of the tree 160, which correspond to the individual moments (or a time period which cannot further be subdivided based upon the definition of the tree structure). Once the tree 160 is constructed in this manner, individual appointments can be placed on the RI tree structure by aligning the start and end times of the individual appointments with the individual moments (the nodes) of the tree 160. Fork nodes are then identified for each interval, as aligned.

Referring to FIG. 2B, assume that the relatively large time period is broken into individual moments, and the moments are represented by the dots shown generally at 160 (dots 1-15). Assume that there are a set of appointments that are placed on the tree 160, and those appointments are labeled A-E. For example, appointment A is scheduled over the interval ranging from moments 2-3 on tree 160. Appointment B is scheduled over the interval ranging from moments 3-6. Appointment C is scheduled over the interval ranging from moments 6-11. Appointment D is scheduled over the interval ranging from moments 12-14 and appointment E is scheduled over the interval ranging from moments 13-15. It will be noted that the relatively large time period is only broken into 15 individual moments, but this is for the sake of example only. In a larger calendar, the relatively large time period may correspond to multiple years, and each individual moment may be a single nanosecond. Therefore, there may be many billions or trillions of individual moments (and thus nodes) represented in a modified RI tree structure. Only individual intervals 1-15 are shown in FIG. 2B, for the sake of example.

Also, it will again be noted that the tree structure is merely a mechanism that can be used to describe how fork nodes work. In practice, however, very few of the trillions of nodes are actually instantiated. Instead, the tree is more of a virtual tree where most of the nodes do not exist in memory. The tree appears much like a database table rather than a true tree-type data structure. The nodes can be calculated, instead of found by tracing the tree structure. The present discussion, however, proceeds with reference to using tree 160, for the sake of example only.

Using tree 160, a fork node for each appointment A-E can be identified. The trunk of the tree structure 160 is 8, because this is the center of the time period represented by interval 1-15. The first branch then subdivides the interval 1-8, and the second branch sub-divides the interval 8-15. Therefore, arrow 162 corresponds to the first branch in the tree 160, because it extends from node 8 to node 4. Arrow 164 corresponds to the second branch, because it extends from node 8 to node 12 (which subdivides the interval 8-15). The next branch is identified by arrow 166, because it subdivides the interval 1-4, and points to node 2. The fourth branch is identified by arrow 168, because it points from node 12 to node 14, thus subdividing the intervals 12-16. This continues with branches descending from each fork node (or parent node) to no more than two child nodes (or dependent nodes). Each appointment is assigned a fork node which corresponds to the first fork node in the tree structure 160 which lies within the corresponding appointment (including its lower and upper bounds, or start and end times). For instance, it can be seen that appointment A extends between moments 2 and 3. The first fork node (the one highest up in tree 160) that is included in appointment A is fork node 2. Therefore, interval A is assigned a fork node 2. Similarly, appointment B is an interval that extends from moment 3 to moment 6. The first fork node in the tree structure 160 that is within appointment B is fork node 4. Appointment C is an interval that extends from moments 6-11. Therefore, the first fork node is actually the trunk, 8, which is contained in the interval defined by appointment C. Appointment D extends from moment 12 to moment 14, and the first fork node that is contained in appointment D is fork node 12. Appointment E is an interval that extends from moment 13 to moment 15, and the first fork node that is contained in interval E is the fork node 14.

FIG. 3 is one example of calendar range query index 128 that indexes each of the appointments A-E based on their corresponding fork nodes. Appointment A extends from moment 2—moment 3 and is assigned fork node 2. Appointment B extends between moments 3-6 and is assigned fork node 4. Appointment C extends between moments 6-11 and is assigned fork node 8. Appointment D extends between moments 12-14 and is assigned fork node 12 and appointment E extends from moment 13 to moment 15 and is assigned fork node 14. Thus, FIG. 3 shows an index in which each of the appointments is indexed by its corresponding, assigned fork node.

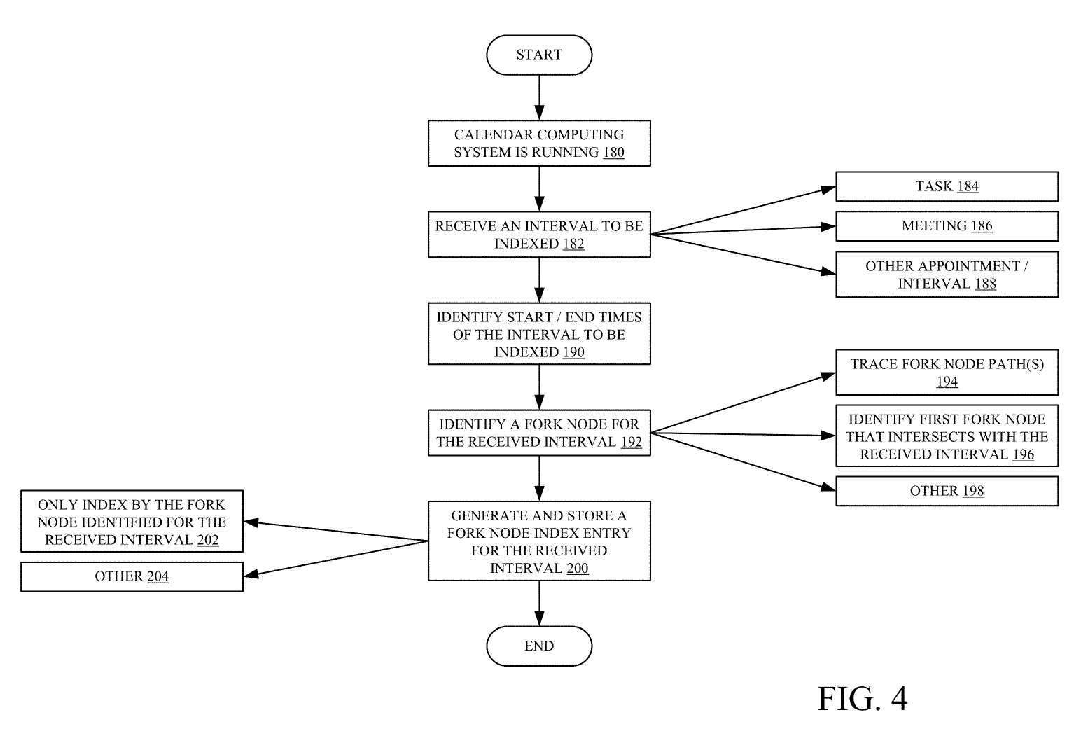

FIG. 4 shows one example of the operation of indexing logic 114 in generating a calendar range query index 128 for appointments within a user's calendar. It is first assumed that the calendar computing system 102 is running This is indicated by block 180 in FIG. 4. Thus, the calendar functionality logic 120 illustratively exposes interfaces that allow user 108 to perform a variety of different calendar functions, including scheduling an appointment.

Indexing logic 114 then receives an interval to be indexed. This is indicated by block 182. For instance, it may be that user 108 has used various user input mechanisms 106 in order to schedule a task 184, a meeting 186, or another appointment or interval 188. Interval identifier logic 132 then identifies the start and end times of the interval to be indexed. This is indicated by block 190.

Fork node assignment logic 134 then identifies a fork node for the received interval. This is indicated by block 192. For instance, fork node assignment logic 134 illustratively traces the fork node paths through the tree 160, given the start and end times of the interval to be indexed. Tracing the fork node paths is indicated by block 194. Fork node assignment logic 134 then illustratively identifies the first fork node in the path being traced (the fork node highest up in tree 160) that intersects with the received interval (that lies within that interval, including its start and end times). This is indicated by block 196. The fork node can be identified in other ways as well, such as directly identifying or calculating it, instead of tracing the paths, and this is indicated by block 198.

Data store interaction logic 136 then generates and stores a fork node index entry in calendar range query index 128 for the received interval (e.g., for the appointment). This is indicated by block 200 in the flow diagram of FIG. 4. In one example, it only indexes the interval by the fork node identified. This is indicated by block 202. This is in distinction to some RI tree structures and static RI tree structures which not only index the interval to be indexed by its fork node, but also by its start time and/or end time. In those types of RI tree structures, multiple different binary searches are performed to identify overlapping intervals, including a first search through a fork node/start time index and a second search through a fork node/end time index. The fork node/start time index is sorted first by fork node, and then intervals with matching fork nodes are further sorted by their start times. Likewise, the fork node/end time index is sorted first by fork node, and then intervals with matching fork nodes are further sorted by end time. In contrast, calendar range query index 128 only indexes the appointment (or interval) based upon its assigned fork node. Generating and storing the fork node index entry for the received interval can be performed in other ways as well, and this is indicated by block 204.

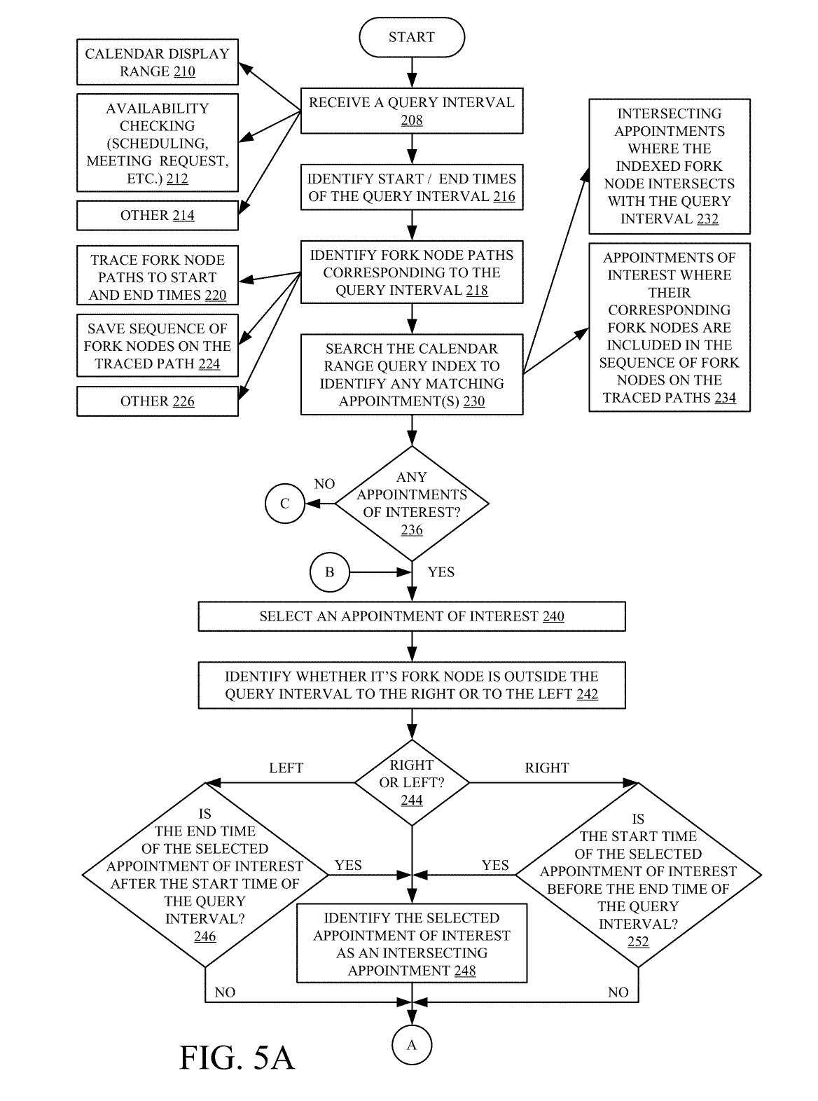

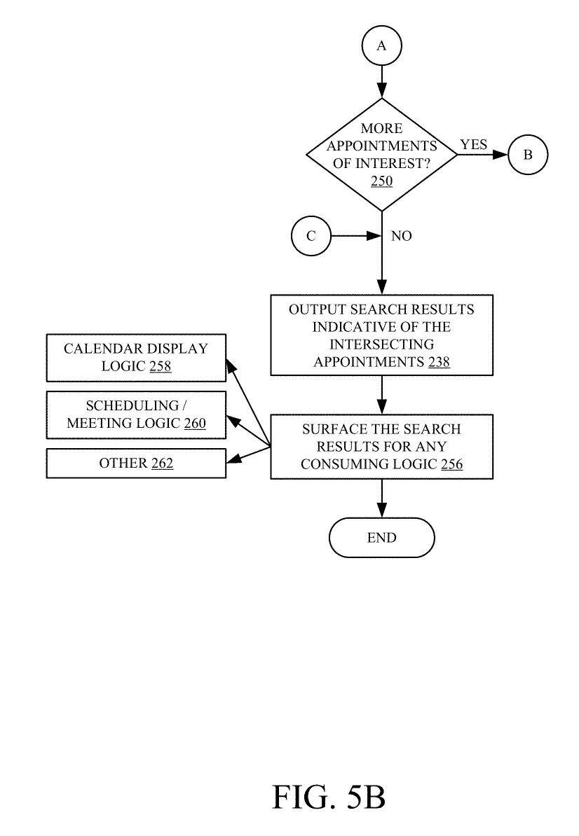

FIGS. 5A and 5B (collectively referred to herein as FIG. 5) show one example of the operation of query interval search system 116 in identifying appointments that intersect with a query interval. System 116 first receives a query interval for searching. This is indicated by block 208 in the flow diagram of FIG. 5. This can be received in a wide variety of different ways. For instance, it may be that user interface logic 118 is generating a display of a calendar view (such as a month view, a week view, a day view, etc.). Thus, it then wants to display all appointments that reside within, or intersect with, that query interval. Receiving the query interval as a calendar display range is indicated by block 210. It may also be that user 108 is attempting to check the availability of other users given their calendar data, during a certain time interval. In that case, the query interval can be received as a time interval during which user 108 wishes to see the availability of other users in order to perform scheduling, send meeting requests, etc. This is indicated by block 212. The query interval can be received in other ways as well, and this is indicated by block 214.

Query interval identifier logic 140 identifies the start and end times of the query interval. This is indicated by block 216.

In one example, logic 140 can provide the query interval start time and end time to fork node path tracing logic 152 to identify fork node paths corresponding to the query interval. This is indicated by block 218. Logic 152 can do this by tracing the fork node paths through the tree 160 to the start time and end time corresponding to the query interval. This is indicated by block 220. Fork node path tracing logic 152 also illustratively saves the set of fork nodes encountered on the path that it traveled through, while tracing the path to the start time and end time corresponding to the query interval. This is indicated by block 224. It can identify the fork nodes on the paths leading to the start time and end time corresponding to the query interval in other ways as well, and this is indicated by block 226.

By way of example, and referring again to FIG. 2, it is assumed that the query interval is represented by the interval which extends between moments 5 and 7.

Index search logic 144 then searches the calendar range query index 128 to identify any matching appointments. This is indicated by block 230 in the flow diagram of FIG. 5. Intersecting appointment identifier logic 146 illustratively uses fork node intersection identifier 150 to identify intersecting appointments where the indexed fork node for an appointment directly intersects with the query interval. This is indicated by block 232. It can be seen from index 128 that there are no appointments with indexed fork nodes that are directly intersecting with the query interval because none of the fork nodes in the index entries for appointments A-E lie within the query interval 5-7.

However, fork node path tracing logic 152 identifies the fork nodes in the paths traced to the start and end of the query interval to determine whether any of the fork nodes in the index entries in index 128 for appointments A-E are in the set of fork nodes in the traced paths. Thus, in order to identify the path to the start of the query interval, fork node path tracing logic 152 first traces the fork node branch represented by arrow 162. It arrives at fork node 4. This is not contained in the query interval (which extends from moments 5-7), so it then traces backward to subdivide the interval 4-8, to arrive at moment 6. This is indicated by arrow 228. The fork node 6 lies in the query interval, and therefore it is the fork node assigned to the query interval. The path traced by fork node path tracing logic 152 in order to arrive at the start of the query interval includes fork node 8 (the trunk), fork node 4, fork node 6, and fork node 5. The path traced by fork node path tracing logic 152 in order to arrive at the end of the query interval includes fork node 8, fork node 4, fork node 6, and fork node 7.

Since the traced paths include fork nodes 8 and 4, it can be seen that appointments B and C are identified as appointments of interest (or potentially intersecting appointments), because though they are not directly intersecting appointments, they have fork nodes that lie within the set of fork nodes on the paths traced by fork node path tracing logic 152. Identifying the appointments of interest (or potentially intersecting appointments) where their corresponding fork node are included in the set of fork nodes on the traced paths is indicated by block 234 in the flow diagram of FIG. 5. Intersecting appointment identifier logic 146 then determines whether there are any appointments of interest (or potentially intersecting appointments) at block 236. If not, processing proceeds to block 238 where the search results are output, and are indicative of any intersecting appointments. In this case, there would be no intersecting appointments output.

However, if, at block 236, it is determined that there are appointments of interest (or potentially intersecting appointments) identified, then overlapping appointment identifier logic 154 selects an appointment of interest for processing. This is indicated by block 240. It then identifies whether the fork node for the appointment of interest is outside the query interval to the right or to the left along the sequence of intervals 160. This is indicated by block 242. Assume, for the sake of example, that overlapping appointment identifier logic 154 selects appointment B as the first appointment of interest. It then determines, based upon the assigned fork node (fork node 4) whether that fork node is outside the query interval to the right or to the left (e.g., whether it is on the lower side of tree 160 or the higher side). It can be seen that fork node 4 is outside of the query interval to its left along the sequence of intervals 160. This is identified at block 244.

Because the fork node lies to the left of the query interval, overlapping appointment identifier logic 154 then determines whether the end time of appointment B is after the start time of the query interval. It can be seen that the end time of appointment B is 6 while the start time of the query interval is 5. Thus, the end time of the selected appointment of interest (appointment B) is indeed after the start time of the query interval as indicated by block 246. In that case, it is determined that appointment B overlaps (or intersects with) the query interval. Thus, appointment B is identified as an intersecting appointment. This is indicated by block 248.

Overlapping appointment identifier logic 154 then determines whether there are any more appointments to be processed. This is indicated by block 250. It can be seen using the present example that there are, because appointment C is another appointment of interest (or potentially intersecting appointment) and it has not yet been processed. Therefore, processing reverts to block 240 where logic 154 selects appointment C as the next selected appointment of interest. It identifies that the fork node for appointment C (which corresponds to node 8) is outside of the query interval to its right along the sequence of moments in tree 160. Therefore, it determines whether the start time of the selected appointment of interested (the start time of appointment C) is before the end time of the query interval. This is indicated by block 252 in the flow diagram of FIG. 5. Because the start time of appointment C is 6 and the end time of the query interval is 7, then it is determined that, indeed, the start time of appointment C is before the end time of the query interval, and thus appointment C is also identified as an intersecting appointment at block 248.

Once all of the appointments of interest have been processed, then intersecting appointment identifier logic 146 outputs the search results which indicate all of the intersecting appointments, that intersect with the query interval. Again, this is indicated by block 238. User interface logic 118 (or other logic) can then surface the search results for any consuming logic. This is indicated by block 256 in the flow diagram of FIG. 5.

For instance, where the consuming logic is logic that is displaying a calendar display (such as a month view, a week view, etc.) then the search results are surfaced to the calendar display logic. This is indicated by block 258. If the logic that is consuming the search results is logic that is displaying to user 108 the availability of various users during a specified time frame, then the search results can be surfaced to the scheduling or meeting logic that is being used to view the availability. This is indicated by block 260. It will be appreciated that the search results can be used by a wide variety of other functionality either in calendar computing system 102, or outside of it. This is indicated by block 262.

It can thus be seen that the present description greatly improves the calendar computing system, itself. It indexes appointments only by fork node, using a modified RI tree structure. Instead of indexing the appointments based on both the fork node and the start/end times (as is done using a conventional RI tree structure and a static RI tree structure), it only generates one index using one indexing parameter. This reduces the memory and computing overhead needed to generate the index, by half. It also greatly reduces the binary search time in identifying appointments that intersect with a query interval, because only the fork node index (e.g., the calendar range query index 128) needs to be searched. By the very nature of calendar data, there will likely not be a great number of appointments that have fork nodes qualifying them as appointments of interest. Therefore, each appointment of interest can be linearly processed by examining it to find out its start and/or end time, and to see whether it overlaps with the query interval, once it has been identified as an appointment of interest (or potentially intersecting appointments) using the fork node index. This allows intersecting appointments (that intersect with a query interval) to be very quickly and accurately identified, using less computing overhead and less memory, than if a conventional RI tree or static RI tree were to be used.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

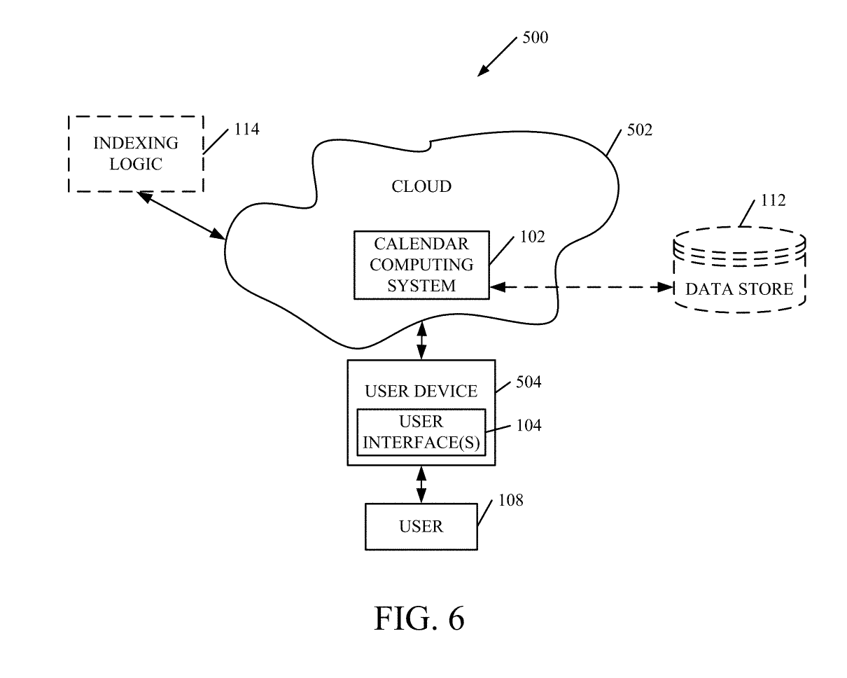

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that calendar computing system 102 can be located in cloud 502 (which can be public, private, or a combination where portions are public while others are private). Therefore, user 108 uses a user device 504 to access those systems through cloud 502.

FIG. 6 also depicts another embodiment of a cloud architecture. FIG. 6 shows that it is also contemplated that some elements of computing system 102 can be disposed in cloud 502 while others are not. By way of example, data store 112 can be disposed outside of cloud 502, and accessed through cloud 502. In another example, indexing logic 114 (or other items) can be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

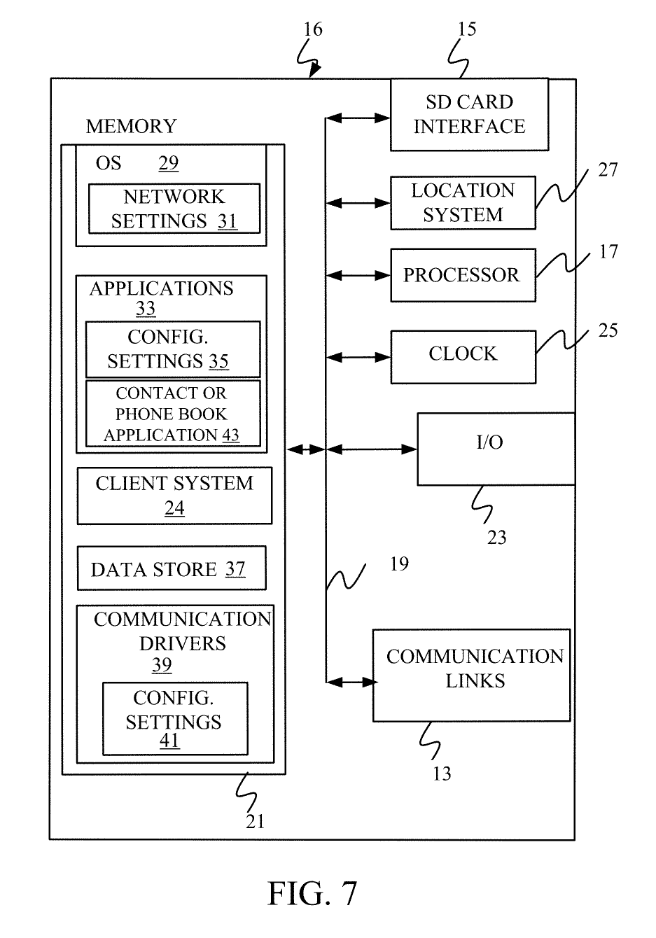

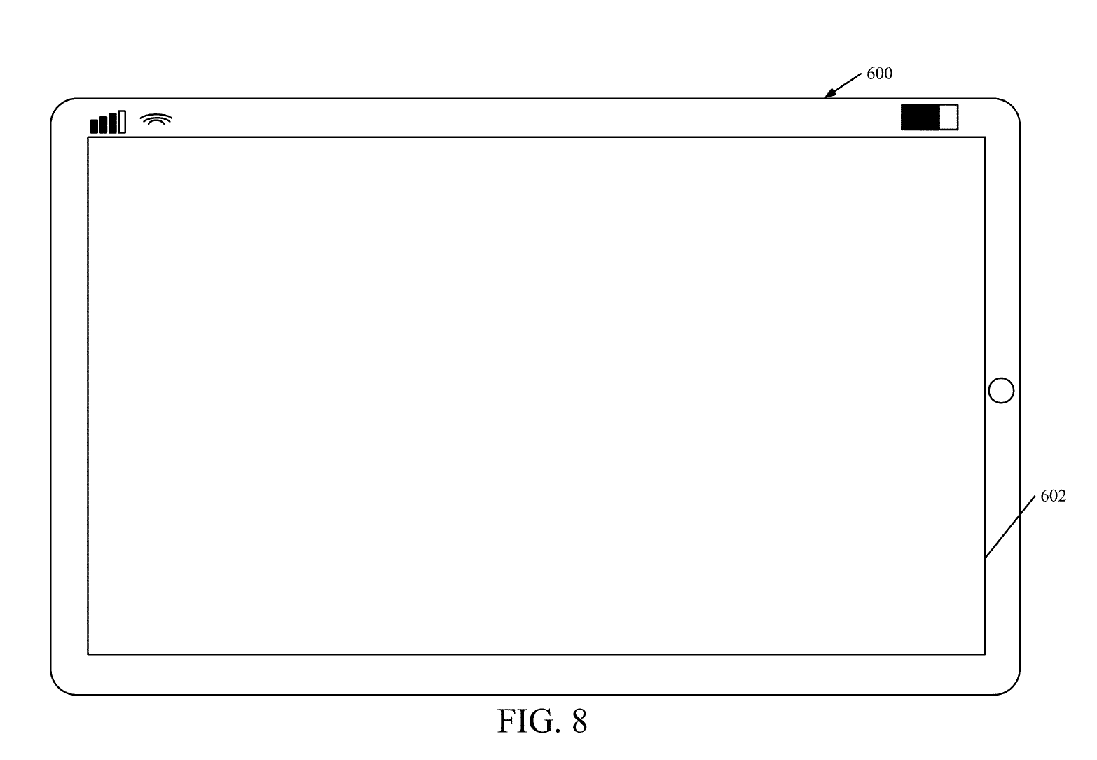

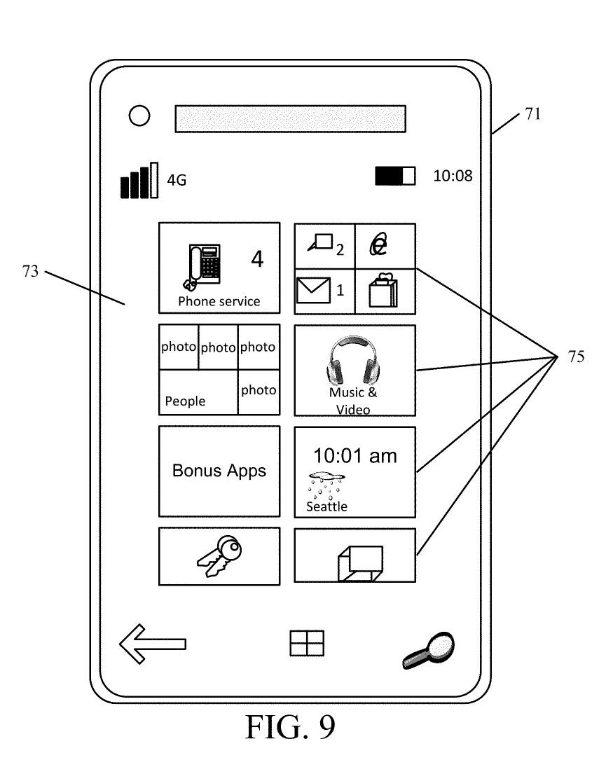

FIG. 7 is a simplified block diagram of one illustrative example of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components computing system 102 or user device 504 or system 116 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one example in which device 16 is a tablet computer 600. In FIG. 8, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 9 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

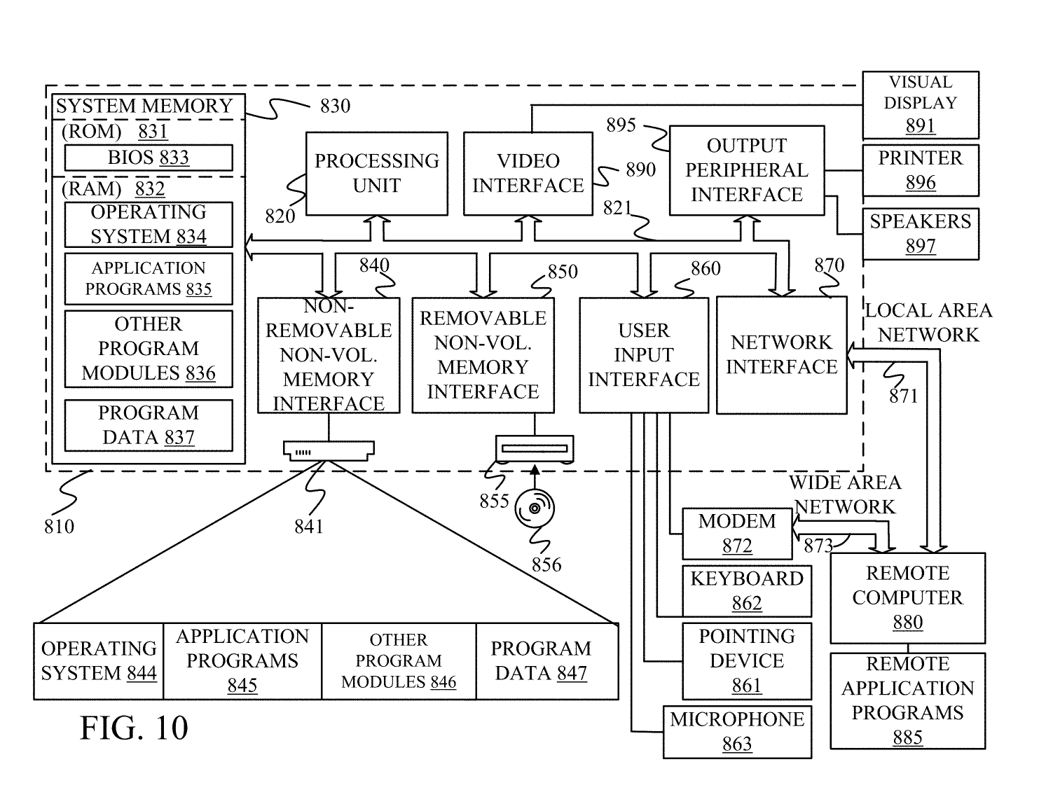

FIG. 10 is one example of a computing environment in which architecture 100, or parts of it, (for example) can be deployed. With reference to FIG. 10, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

calendar functionality logic that exposes an interface to schedule an appointment, with a start time and an end time, on a user's calendar;

indexing logic that that identifies a fork node corresponding to the appointment in a binary tree based on the start time and end time and indexes the appointment by its corresponding fork node, in a calendar range query index; and

a query interval search system that receives a query interval with a start time and an end time and accesses the calendar range query index to identify whether the appointment intersects with the query interval based on whether the fork node corresponding to the appointment is in a range defined by the start time and the end time of the query interval and based on whether the fork node corresponding to the appointment lies on a path through the binary tree from a trunk of the binary tree to the start time or the end time of the query interval.

Example 2 is the computing system of any or all previous examples wherein the query interval search system comprises:

overlapping appointment identifier logic configured to identify the appointment as potentially intersecting with the query interval if the fork node corresponding to the appointment is not within the range defined by the start time and the end time of the query interval and if the fork node corresponding to the appointment lies on the path through the binary tree from the trunk to the start or end time corresponding to the query interval.

Example 3 is the computing system of any or all previous examples wherein the overlapping appointment identifier logic is configured to access the start time or the end time for the potentially intersecting appointment to determine whether the potentially intersecting appointment intersects with the query interval based on the end time or start time of the query interval.

Example 4 is the computing system of any or all previous examples wherein the query interval search system comprises:

fork node path tracing logic configured to trace the path through the binary tree and identify whether the fork node corresponding to the potentially intersecting appointment lies on a lower side of the binary tree relative to the query interval or on an upper side of the binary tree relative to the query interval.

Example 5 is the computing system of any or all previous examples wherein, when the fork node corresponding to the potentially intersecting appointment lies on a lower side of the binary tree relative to the query interval, the overlapping appointment identifier logic is configured to compare the end time for the potentially intersecting appointment with the start time of the query interval to determine whether the end time of the potentially intersecting appointment is after the start time of the query interval and, if so, identify the potentially intersecting appointment as an intersecting appointment that intersects with the query interval.

Example 6 is the computing system of any or all previous examples wherein, when the fork node corresponding to the potentially intersecting appointment lies on an upper side of the binary tree relative to the query interval, the overlapping appointment identifier logic is configured to compare the start time for the potentially intersecting appointment with the end time of the query interval to determine whether the start time of the potentially intersecting appointment is before the end time of the query interval and, if so, identify the potentially intersecting appointment as an intersecting appointment that intersects with the query interval.

Example 7 is the computing system of any or all previous examples wherein the query interval search system comprises:

fork node identifier logic configured to identify the fork node in the binary tree corresponding to the query interval.

Example 8 is the computing system of any or all previous examples wherein the user's calendar includes a plurality of potentially intersecting appointments and wherein the overlapping appointment identifier logic is configured to process each of the potentially intersecting appointments, to determine whether each potentially intersecting appointment is an intersecting appointment, by performing a comparison of the start time or end time of each appointment to the end time or start time of the query interval, based on whether the fork node corresponding to each potentially intersecting appointment lies on the upper side or the lower side of the binary tree relative to the query interval.

Example 9 is a computer implemented method, comprising:

exposing an interface to schedule an appointment, with a start time and an end time, on a user's calendar;

identifying a fork node corresponding to the appointment in a binary tree based on the start time and end time of the appointment

indexing the appointment by its corresponding fork node, in a calendar range query index;

receiving a query interval with a start time and an end time;

accessing the calendar range query index and identifying whether the appointment intersects with the query interval based on whether the fork node corresponding to the appointment is in a range defined by the start time and the end time of the query interval and based on whether the fork node corresponding to the appointment lies on a path through the binary tree from a trunk of the binary tree to the start time or end time corresponding to the query interval.

Example 10 is the computer implemented method of any or all previous examples wherein identifying whether the appointment intersects with the query interval comprises:

identifying the appointment as potentially intersecting with the query interval if the fork node corresponding to the appointment is not within the range defined by the start time and the end time of the query interval and if the fork node corresponding to the appointment lies on the path through the binary tree from the trunk to the start time or end time corresponding to the query interval.

Example 11 is the computer implemented method of any or all previous examples wherein identifying whether the appointment intersects with the query interval comprises:

accessing the start time or the end time for the potentially intersecting appointment to determine whether the potentially intersecting appointment intersects with the query interval based on the end time or start time of the query interval.

Example 12 is the computer implemented method of any or all previous examples wherein identifying the appointment as potentially intersecting with the query interval comprises:

tracing the path through the binary tree; and

identifying whether the fork node corresponding to the potentially intersecting appointment lies on a lower side of the binary tree relative to the query interval or on an upper side of the binary tree relative to the query interval.

Example 13 is the computer implemented method of any or all previous examples wherein identifying whether the appointment intersects with the query interval comprises:

when the fork node corresponding to the potentially intersecting appointment lies on a lower side of the binary tree relative to the query interval, comparing the end time for the potentially intersecting appointment with the start time of the query interval to determine whether the end time of the potentially intersecting appointment is after the start time of the query interval; and

if so, identifying the potentially intersecting appointment as an intersecting appointment that intersects with the query interval.

Example 14 is the computer implemented method of any or all previous examples wherein identifying whether the appointment intersects with the query interval comprises:

when the fork node corresponding to the potentially intersecting appointment lies on an upper side of the binary tree relative to the query interval, comparing the start time for the potentially intersecting appointment with the end time of the query interval to determine whether the start time of the potentially intersecting appointment is before the end time of the query interval; and

if so, identifying the potentially intersecting appointment as an intersecting appointment that intersects with the query interval.

Example 15 is the computer implemented method of any or all previous examples wherein the user's calendar includes a plurality of potentially intersecting appointments and wherein identifying whether the appointment intersects with the query interval comprises:

selecting one of the plurality of potentially intersecting appointments;

processing the selected potentially intersecting appointment to determine whether the selected potentially intersecting appointment is an intersecting appointment; and

repeatedly selecting one of the potentially intersecting appointments and processing the selected potentially intersecting appointment until all of the plurality of potentially intersecting appointments are processed.

Example 16 is the computer implemented method of any or all previous examples wherein processing the selected potentially intersecting appointment comprises:

performing a comparison of the start time or end time of the selected potentially intersecting appointment to the end time or start time of the query interval, based on whether the fork node corresponding to the selected potentially intersecting appointment lies on the upper side or the lower side of the binary tree relative to the query interval.

Example 17 is a computing system, comprising:

calendar functionality logic that exposes an interface to schedule an appointment, with a start time and an end time, on a user's calendar;

indexing logic that that identifies a fork node corresponding to the appointment in a binary tree based on the start time and end time and indexes the appointment by its corresponding fork node, in a calendar range query index;

a query interval search system that receives a query interval with a start time and an end time and accesses the calendar range query index to identify whether the appointment intersects with the query interval based on whether the fork node corresponding to the appointment is in a range defined by the start time and the end time of the query interval; and

overlapping appointment identifier logic configured to identify the appointment as potentially intersecting with the query interval if the fork node corresponding to the appointment is not within the range defined by the start time and the end time of the query interval and if the fork node corresponding to the appointment lies on a path through the binary tree from a trunk to the start time or end time corresponding to the query interval.

Example 18 is the computing system of any or all previous examples wherein the overlapping appointment identifier logic is configured to access the start time or the end time for the potentially intersecting appointment to determine whether the potentially intersecting appointment intersects with the query interval based on the end time or start time of the query interval.

Example 19 is the computing system of any or all previous examples wherein the query interval search system comprises:

fork node path tracing logic configured to trace the path through the binary tree and identify whether the fork node corresponding to the potentially intersecting appointment lies on a lower side of the binary tree relative to the query interval or on an upper side of the binary tree relative to the query interval.

Example 20 is the computing system of any or all previous examples wherein, when the fork node corresponding to the potentially intersecting appointment lies on a lower side of the binary tree relative to the query interval, the overlapping appointment identifier logic is configured to compare the end time for the potentially intersecting appointment with the start time of the query interval to determine whether the end time of the potentially intersecting appointment is after the start time of the query interval and, if so, identify the potentially intersecting appointment as an intersecting appointment that intersects with the query interval, and wherein, when the fork node corresponding to the potentially intersecting appointment lies on an upper side of the binary tree relative to the query interval, the overlapping appointment identifier logic is configured to compare the start time for the potentially intersecting appointment with the end time of the query interval to determine whether the start time of the potentially intersecting appointment is before the end time of the query interval and, if so, identify the potentially intersecting appointment as an intersecting appointment that intersects with the query interval.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
calendar functionality logic that exposes an interface to schedule an appointment, with a start time and an end time, on a user's calendar;
indexing logic that that identifies a fork node corresponding to the appointment in a binary tree based on the start time and end time and indexes the appointment by its corresponding fork node, in a calendar range query index; and
a query interval search system that receives a query interval with a start time and an end time and identifies a fork node in the binary tree corresponding to the query interval and accesses the calendar range query index to identify whether the appointment intersects with the query interval based on whether the fork node corresponding to the appointment is in a range defined by the start time and the end time of the query interval and based on whether the fork node corresponding to the appointment lies on a path through the binary tree from a trunk of the binary tree to the start time or end time corresponding to the query interval.

2. The computing system of claim 1 wherein the query interval search system comprises:
overlapping appointment identifier logic configured to identify the appointment as potentially intersecting with the query interval if the fork node corresponding to the appointment is not within the range defined by the start time and the end time of the query interval and if the fork node corresponding to the appointment lies on the path through the binary tree from the trunk to the start time or end time corresponding to the query interval.

3. The computing system of claim 2 wherein the overlapping appointment identifier logic is configured to access the start time or the end time for the potentially intersecting appointment to determine whether the potentially intersecting appointment intersects with the query interval based on the end time or start time of the query interval.

4. The computing system of claim 3 wherein the query interval search system comprises:
fork node path tracing logic configured to trace the path through the binary tree and identify whether the fork node corresponding to the potentially intersecting appointment lies on a lower side of the binary tree relative to the query interval or on an upper side of the binary tree relative to the query interval.

5. The computing system of claim 4 wherein, when the fork node corresponding to the potentially intersecting appointment lies on a lower side of the binary tree relative to the query interval, the overlapping appointment identifier logic is configured to compare the end time for the potentially intersecting appointment with the start time of the query interval to determine whether the end time of the potentially intersecting appointment is after the start time of the query interval and, if so, identify the potentially intersecting appointment as an intersecting appointment that intersects with the query interval.

6. The computing system of claim 5 wherein, when the fork node corresponding to the potentially intersecting appointment lies on an upper side of the binary tree relative to the query interval, the overlapping appointment identifier logic is configured to compare the start time for the potentially intersecting appointment with the end time of the query interval to determine whether the start time of the potentially intersecting appointment is before the end time of the query interval and, if so, identify the potentially intersecting appointment as an intersecting appointment that intersects with the query interval.

7. The computing system of claim 4 wherein the query interval search system comprises:
fork node identifier logic configured to identify the fork node in the binary tree corresponding to the query interval.

8. The computing system of claim 6 wherein the user's calendar includes a plurality of potentially intersecting appointments and wherein the overlapping appointment identifier logic is configured to process each of the potentially intersecting appointments, to determine whether each potentially intersecting appointment is an intersecting appointment, by performing a comparison of the start time or end time of each appointment to the end time or start time of the query interval, based on whether the fork node corresponding to each potentially intersecting appointment lies on the upper side or the lower side of the binary tree relative to the query interval.

9. A computer implemented method, comprising:
exposing an interface to schedule an appointment, with a start time and an end time, on a user's calendar;
identifying a fork node corresponding to the appointment in a binary tree based on the start time and end time of the appointment
indexing the appointment by its corresponding fork node, in a calendar range query index;
receiving a query interval with a start time and an end time;
accessing the calendar range query index and identifying whether the appointment intersects with the query interval based on whether the fork node corresponding to the appointment is in a range defined by the start time and the end time of the query interval and based on whether the fork node corresponding to the appointment lies on a path through the binary tree from a trunk of the binary tree to the start time or end time corresponding to the query interval.

10. The computer implemented method of claim 9 wherein identifying whether the appointment intersects with the query interval comprises:
identifying the appointment as potentially intersecting with the query interval if the fork node corresponding to the appointment is not within the range defined by the start time and the end time of the query interval and if the fork node corresponding to the appointment lies on the path through the binary tree from the trunk to the start time or end time corresponding to the query interval.

11. The computer implemented method of claim 10 wherein identifying whether the appointment intersects with the query interval comprises:
accessing the start time or the end time for the potentially intersecting appointment to determine whether the potentially intersecting appointment intersects with the query interval based on the end time or start time of the query interval.

12. The computer implemented method of claim 11 wherein identifying the appointment as potentially intersecting with the query interval comprises:
tracing the path through the binary tree; and
identifying whether the fork node corresponding to the potentially intersecting appointment lies on a lower side of the binary tree relative to the query interval or on an upper side of the binary tree relative to the query interval.

13. The computer implemented method of claim 12 wherein identifying whether the appointment intersects with the query interval comprises:
when the fork node corresponding to the potentially intersecting appointment lies on a lower side of the binary tree relative to the query interval, comparing the end time for the potentially intersecting appointment with the start time of the query interval to determine whether the end time of the potentially intersecting appointment is after the start time of the query interval; and
if so, identifying the potentially intersecting appointment as an intersecting appointment that intersects with the query interval.

14. The computer implemented method of claim 13 wherein identifying whether the appointment intersects with the query interval comprises:
when the fork node corresponding to the potentially intersecting appointment lies on an upper side of the binary tree relative to the query interval, comparing the start time for the potentially intersecting appointment with the end time of the query interval to determine whether the start time of the potentially intersecting appointment is before the end time of the query interval; and
if so, identifying the potentially intersecting appointment as an intersecting appointment that intersects with the query interval.

15. The computer implemented method of claim 14 wherein the user's calendar includes a plurality of potentially intersecting appointments and wherein identifying whether the appointment intersects with the query interval comprises:
selecting one of the plurality of potentially intersecting appointments;
processing the selected potentially intersecting appointment to determine whether the selected potentially intersecting appointment is an intersecting appointment; and
repeatedly selecting one of the potentially intersecting appointments and processing the selected potentially intersecting appointment until all of the plurality of potentially intersecting appointments are processed.

16. The computer implemented method of claim 15 wherein processing the selected potentially intersecting appointment comprises:
performing a comparison of the start time or end time of the selected potentially intersecting appointment to the end time or start time of the query interval, based on whether the fork node corresponding to the selected potentially intersecting appointment lies on the upper side or the lower side of the binary tree relative to the query interval.

17. A computing system, comprising:
calendar functionality logic that exposes an interface to schedule an appointment, with a start time and an end time, on a user's calendar;
indexing logic that that identifies a fork node corresponding to the appointment in a binary tree based on the start time and end time and indexes the appointment by its corresponding fork node, in a calendar range query index;
a query interval search system that receives a query interval with a start time and an end time and accesses the calendar range query index to identify whether the appointment intersects with the query interval based on whether the fork node corresponding to the appointment is in a range defined by the start time and the end time of the query interval; and
overlapping appointment identifier logic configured to identify the appointment as potentially intersecting with the query interval if the fork node corresponding to the appointment is not within the range defined by the start time and the end time of the query interval and if the fork node corresponding to the appointment lies on a path through the binary tree from a trunk to the start time or end time corresponding to the query interval.

18. The computing system of claim 17 wherein the overlapping appointment identifier logic is configured to access the start time or the end time for the potentially intersecting appointment to determine whether the potentially intersecting appointment intersects with the query interval based on the end time or start time of the query interval.

19. The computing system of claim 18 wherein the query interval search system comprises:
fork node path tracing logic configured to trace the path through the binary tree and identify whether the fork node corresponding to the potentially intersecting appointment lies on a lower side of the binary tree relative to the query interval or on an upper side of the binary tree relative to the query interval.

20. The computing system of claim 19 wherein, when the fork node corresponding to the potentially intersecting appointment lies on a lower side of the binary tree relative to the query interval, the overlapping appointment identifier logic is configured to compare the end time for the potentially intersecting appointment with the start time of the query interval to determine whether the end time of the potentially intersecting appointment is after the start time of the query interval and, if so, identify the potentially intersecting appointment as an intersecting appointment that intersects with the query interval, and wherein, when the fork node corresponding to the potentially intersecting appointment lies on an upper side of the binary tree relative to the query interval, the overlapping appointment identifier logic is configured to compare the start time for the potentially intersecting appointment with the end time of the query interval to determine whether the start time of the potentially intersecting appointment is before the end time of the query interval and, if so, identify the potentially intersecting appointment as an intersecting appointment that intersects with the query interval.
